(19) United States
(12) Patent Application Publication
(10) Pub. No.: US 2009/0175486 A1
(43) Pub. Date: Jul. 9, 2009

(54) SPEAKER

(75) Inventor: Takashi Suzuki, Meguro-ku (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Tokyo (JP)

(21) Appl. No.: 12/162,747

(22) PCT Filed: Jan. 18, 2007
(86) PCT No.: PCT/JP2007/050710

§ 371 Date: Jul. 30, 2008

(30) Foreign Application Priority Data
Feb. 2, 2006 (JP) 2006-025699

(51) Int. Cl. H04R 9/02

(52) U.S. Cl. 381/412

(57) ABSTRACT

There is provided a speaker, which permits to reduce unnecessary vibration to improve sound quality. The speaker 10 includes a magnetic circuit system 30 exciting a voice coil 23 and having an upper plate 31 and a lower plate 32; and a vibration system 20 having a diaphragm 21 connected to the voice coil 23. The speaker includes an outer frame 41 having one side attached to a lower surface of the lower plate 32; and an inner frame 42 having one side attached to an upper surface of the upper plate 31. Another side of at least one of the inner frame 42 and the outer frame 41 is connected on a diaphragm-mounting surface 41a supporting a circumferential edge of the diaphragm 21. The inner frame 42 and the outer frame 41 are connected to each other at respective another side.

### TECHNICAL FIELD

The present invention relates to a technical field of a frame structure of a speaker.

### BACKGROUND OF THE INVENTION

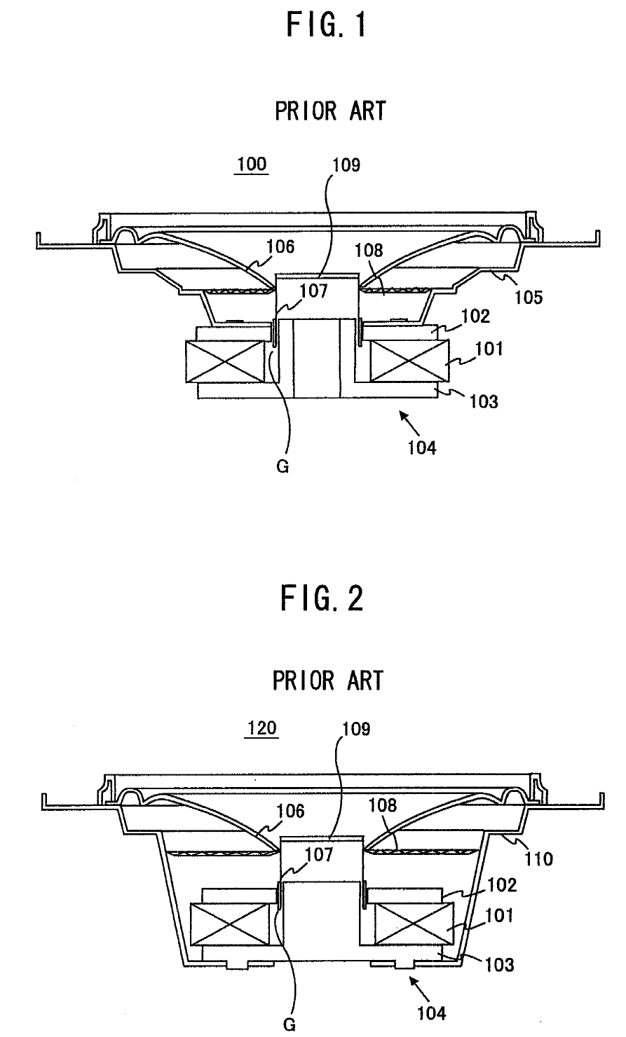

As a frame structure of a speaker, there has conventionally been known the structure as shown in FIGS. 1 and 2.

In the speaker 100 as shown in FIG. 1, a frame 105 is attached on its bottom side, by means of fastening devices such as screws, to an upper surface of an upper plate 102 of a magnetic circuit system 104 in which a magnet 101 is sandwiched between the upper plate 102 and a lower plate (i.e., a yoke) 103, and the frame 105 is attached on its upper side to a circumferential edge of a diaphragm 106. A voice coil 107 for vibrating the diaphragm 16 is held at a central position by means of a damper 108 attached to the frame 105, so as to be put into a magnetic gap “G”. A dust cap 109 is attached to a connection section of the diaphragm 106 and the voice coil 107. The diaphragm 106 and the magnetic circuit system 104 are held by the frame 105 and the voice coil 107 is held so as to be movable up and down along a central axis of the speaker 100, in this manner. Such a frame structure in which the frame 105 is attached on its bottom side to the upper surface of the upper plate 102 of the magnetic circuit system is disclosed also in for example Patent Document 1.

A speaker 120 as shown in FIG. 2 is different from the speaker as shown in FIG. 1 in that a frame 110 is attached on its bottom side to a lower surface of a lower plate 103 of a magnetic circuit system 104 in which a magnet 101 is held between an upper plate 102 and the lower plate 103, but is the same as the speaker as shown in FIG. 1 in the other structural features.

Patent Document 1: Japanese Patent Provisional Publication No. H8-289394

### DISCLOSURE OF THE INVENTION

### Subject to be Solved by the Invention

However, concerning unnecessary vibration of the magnetic circuit system caused by reaction of vibration of the voice coil, the reaction occurs at the connection section of the frame and the magnetic circuit system in the speaker in which the frame is mounted on the upper surface of the upper plate. Accordingly, unnecessary vibration may easily occur, even when the connection between the upper plate and the frame is considerably strengthened, thus causing problems on deterioration in acoustic quality.

In addition, in the speaker in which the frame is attached on the lower surface of the lower plate, the frame is longer than that of the conventional speaker and amplitude of the unnecessary vibration becomes large, thus causing problems on deterioration in acoustic quality.

Further, there is need to make efforts to provide effective attenuation of vibration caused by the loudspeaker, in order to accurately reproduce originally intended sound.

An object of the present invention is to provide a speaker, which permits to solve the above-described examples of problems and reduce unnecessary vibration to improve sound quality.

### Means to Solve the Subject

In order to attain the aforementioned object, the speaker comprises: a magnetic circuit system, which excites a voice coil and has an upper plate and a lower plate; and a vibration system, which has a diaphragm connected to the voice coil, wherein: the speaker comprises: an outer frame having one side, which is attached to a lower surface of the lower plate; and an inner frame having one side, which is attached to an upper surface of the upper plate, and wherein: another side of at least one of the inner frame and the outer frame is connected on a diaphragm mounting surface, which supports a circumferential edge of the diaphragm, and the inner frame and the outer frame are connected to each other at respective another side.

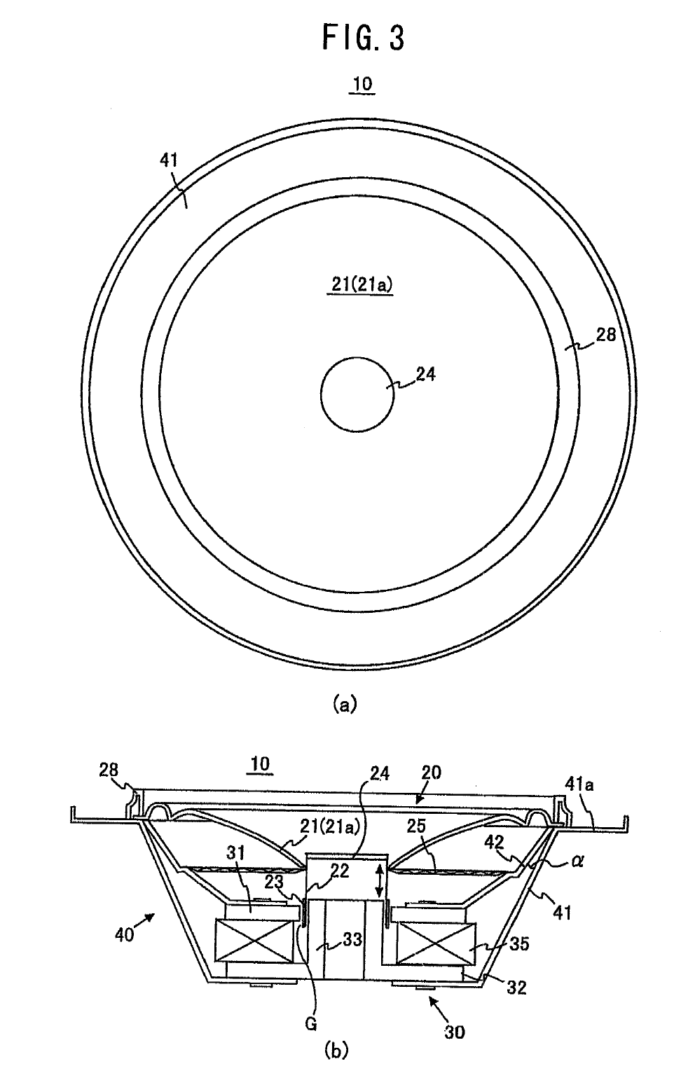

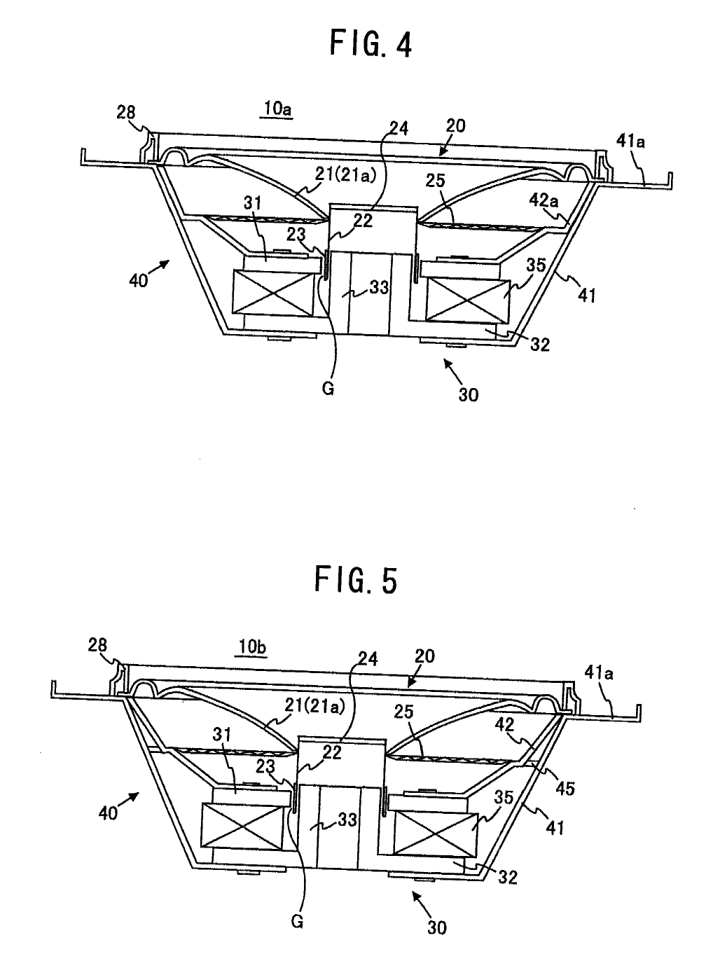

### BRIEF DESCRIPTION OF THE DRAWINGS

[FIG. 1] It is a cross-sectional schematic view illustrating an example of a conventional speaker.

[FIG. 2] It is across-sectional schematic view illustrating an example of a conventional speaker.

[FIG. 3] It is a view illustrating an example of a speaker according to the first embodiment of the present invention.

[FIG. 4] It is a cross-sectional view illustrating an example of a speaker according to the second embodiment of the present invention.

[FIG. 5] It is a cross-sectional view illustrating an example of a speaker according to the third embodiment of the present invention.

### EXPLANATION OF THE REFERENCE NUMERALS

10, 10a, 10b speaker

20 vibration system

21 diaphragm

21a cone

23 voice coil

25 damper

30 magnetic circuit system

31 upper plate

32 lower plate

40 basket

41 outer frame

41a diaphragm-mounting surface

42, 42a inner frame

45 abutment section

### BEST MODE FOR CARRYING OUT THE INVENTION

Now, best modes for carrying out the present invention will be described below with reference to the drawings. A speaker, which will be described below, is a speaker, which is a so-called “cone loudspeaker”.

### First Embodiment

A structure of the speaker according to the first embodiment of the present invention will be described below with reference to FIG. 3.

FIG. 3 is a view illustrating an example of the speaker according to the first embodiment of the present invention, and FIG. 3(a) is a plan view and FIG. 3(b) is a cross-sectional schematic view. For reasons of expediency, description will be given on the assumption that the vertical direction of the speaker 10 as shown in FIG. 3(b) corresponds to the actual vertical direction of the loudspeaker 10 of the present invention.

The speaker 10 according to the first embodiment of the present invention is composed of a vibration system 20, a magnetic circuit system 30 and a basket 40 for holding the vibration system 20 and the magnetic circuit system 30.

As shown in FIGS. 3(a) and 3(b), the vibration system 20 of the speaker 10 is composed of a cone 21a, which serves as a diaphragm 21 and has an inversed-conical and ring shape; a voice coil bobbin 22, which is connected to an inner circumferential edge of the cone 21aand has a cylindrical shape; a voice coil 23, which is wound around the outer periphery of the lower side of the voice coil bobbin 22; a central cap 24, which is fitted on the upper side of the voice coil bobbin 22; and a damper 25, which is sandwiched between the basket 40 and the voice coil bobbin 22.

As shown in FIG. 3(b), the voice coil bobbin 22 is held through the damper 25 on the inner frame 42 of the basket 40 so as to be movable up and down along the central axis of the speaker 10. The cone 21a is fixed at its outer circumferential edge through a gasket 28 to a diaphragm-mounting surface 41a, which is formed so as to extend horizontally outside the cone 21a. Movement of the voice coil bobbin 22 causes the cone 21a to vibrate.

As shown in FIG. 3(b), the magnetic circuit system 30 of the speaker 10 is composed of an upper plate 31, and a lower plate 32 (i.e., a yoke), which are formed of metallic material into a ring shape; a tubular pole piece 33 integrally formed with the lower plate 32 in its central position; and a ring-shaped magnet 35 held between the upper plate 31 and the lower plate 32. The magnet 35 may be excited by a direct current power supply or may be a permanent magnet.

A magnetic gap “G” for receiving the voice coil 23 is provided between the upper plate 31 and the pole piece 33.

The basket 40 of the speaker is provided as shown in FIG. 3(b) with an outer frame 41 and an inner frame 42. The outer frame 41 is fixed on its bottom side (one end portion) to the lower surface of the lower plate 32 by means for example of screws. The inner frame 42 is fixed on its bottom side (one end portion) to the upper surface of the upper plate 31 by means for example of screws. The bottom sides of the outer and inner frames 41, 42 may be fixed by the other securing method such as a calking.

The outer frame 41 is connected (joined) at its upper side (the other end portion) to the diaphragm-mounting surface 41a on which the diaphragm 21 is supported at its periphery. The inner frame 42 and the upper side (the other end portion) of the outer frame 41 are connected (joined) to each other.

More specifically, the magnetic circuit system 30 is held between the inner frame 42 and the outer frame 41 of the basket 40.

The outer frame 41 may be bent at its upper side to form the diaphragm-mounting surface 41a, as shown in FIG. 3(b) so that the above-mentioned upper side serves as the diaphragm-mounting surface 41a on which the above-mentioned cone 21a is supported at its periphery. Alternatively, the outer frame 41 and a member for constituting the diaphragm-mounting surface 41a may be provided independent from each other and joined at their respective edges.

The inner frame 42 is fixed to the outer frame 41 so that an angle (an interior angle) “α” of the inner frame 42 relative to the outer frame 41 at the connection section (the joining portion) at which the inner frame 42 is connected to the diaphragm-mounting surface 41a becomes an acute angle.

The outer and inner frames 41, 42 have a plurality of arms not shown so that these arms extend upwardly and radially. The outer frame 41 is provided so as to support the magnetic circuit system 30 and embrace generally the lower side of the speaker including the magnetic circuit system 30. The inner frame 42 is provided so as to support the voice coil bobbin 22 through the damper 25 to hold the vibration system 20 and embrace the vibration system 20.

The speaker 10 having such a structure is designed so that the voice coil 23 is excited when a current indicative of a sound signal (an excitation signal) is supplied, an electromagnetic force based on the excitation signal is applied to the voice coil bobbin 22 along the central axis of the speaker 10, the voice coil 23 excites together with the voice coil bobbin 22 and the cone 21a up an down along the central axis of the speaker 10 as shown in FIG. 3(b) by an arrow and acoustic energy based on the excitation signal is radiated.

According to the first embodiment of the present invention, the speaker includes the outer frame 41 having the one side, which is attached to the lower surface of the lower plate 32 of the magnetic circuit system 30, and the inner frame having the one side, which is attached to the upper surface of the upper plate 31 of the magnetic circuit system 30, and the other side of at least one of the inner frame 42 and the outer frame 41 is connected on the diaphragm-mounting surface 41a, which supports the circumferential edge of the diaphragm 20, and the inner frame 42 and the outer frame 41 are connected to each other at respective another side, as described above, so that the magnetic circuit system 30 is held between the inner frame 42 and the outer frame 41. It is therefore possible to reduce unnecessary vibration of the magnetic circuit system 30, which is caused by reaction of vibration of the voice coil 23. Consequently, acoustic quality can be improved by such reduction of the unnecessary vibration.

The interior angle between the inner frame 42 and the outer frame 41 is an acute angle at the connection section at which the inner frame 42 and the outer frame 41 are connected to each other, so as to provide a reinforcement structure, thus enhancing rigidity of the basket 40 and permitting a more effective attenuation of the unnecessary vibration caused by the magnetic circuit system 30.

### Second Embodiment

Now, a structure of the speaker according to the second embodiment of the present invention will be described below with reference to FIG. 4.

FIG. 4 is a cross-sectional view illustrating an example of a speaker according to the second embodiment of the present invention. Structural components in FIG. 4, which are common to those in FIG. 3, have the same reference numerals. Description of these components will be omitted.

As shown in FIG. 4, in the speaker 10a according to the second embodiment of the present invention, the inner frame 42a is connected to the outer frame 41 so that the top end of the inner frame 42a is overlapped with the outer frame 41.

Such a structure in which the outer frame 41 and the inner frame 42a are different in length has a function of attenuating vibration in their inherent resonance frequencies of the outer and inner frames 41, 42a, thus providing effects of reducing unnecessary vibration in both of a bass range and a midrange and improving sound quality.

It is preferable to make the outer frame 41 and the inner frame 42a of materials having different physical properties from each other. This permits to make the outer frame 41 and the inner frame 42a remarkably different from each other in their inherent resonance frequencies, thus making it possible to reduce reaction component of the magnetic circuit system 30. More effective reduction of unnecessary vibration can be achieved, thus remarkably improving sound quality.

Concerning combination of materials for the outer frame and the inner frame 42a, combination of aluminum and iron, or combination of aluminum and plastics may be applied for example.

### Third Embodiment

A structure of the speaker according to the third embodiment of the present invention will be described below with reference to FIG. 5.

FIG. 5 is a cross-sectional view illustrating an example of a speaker according to the third embodiment of the present invention. Structural components in FIG. 5, which are common to those in FIG. 3, have the same reference numerals. Description of these components will be omitted.

In the speaker 10a according to the third embodiment of the present invention, the outer frame 41 and the inner frame 42 are brought into contact (may be connected) with each other through abutment sections (i.e., ribs) 45 provided in the vicinity of the connected top edges (i.e., the connection section) of the outer frame 41 and the inner frame 42, as shown in FIG. 5.

More specifically, in the speaker 10b according to the third embodiment of the present invention, the inner frame 42 is provided with abutment sections 45, which comes into contact with the inner wall of the outer frame 41 to provide a mutual transmission path between the inner and outer frames (namely, the abutment sections (i.e., the ribs) 45 project from the inner frame 42 to the outer frame 41). Such abutment sections provided between the outer and inner frames 41, 42 provides a truss structure.

The outer frame 41 may be provided with abutment sections 45, which comes into contact with the outer wall of the inner frame 42 to provide a mutual transmission path between the inner and outer frames.

Providing the truss structure at the connection section at which the outer and inner frames 41, 42 are connected to each other and a high stress may be applied, can remarkably enhance rigidity of the outer and inner frames 41, 42. It is therefore possible to attenuate vibration spreading on the outer and inner frames 41, 42, thus more effectively reducing reaction component of the magnetic circuit system 30. Even more effective reduction of unnecessary vibration can be achieved, thus more remarkably improving sound quality.

The embodiments of the present invention are described above merely as examples, and the present invention is not limited only to these embodiments. In FIG. 3 for example, the outer frame 41 is provided at the top end with the diaphragm-mounting surface 41a, and the inner frame 42 is fixed to the inner side of the diaphragm-mounting surface 41a. However, the inner frame 42 may be provided at the top end with the diaphragm-mounting surface, and the outer frame 41 may be fixed to the outer side of the inner frame 42.

1. A speaker comprising: a magnetic circuit system, which excites a voice coil and has an upper plate and a lower plate; and a vibration system, which has a diaphragm connected to said voice coil, wherein:
said speaker comprises:
an outer frame having one side, which is attached to a lower surface of said lower plate; and
an inner frame having one side, which is attached to an upper surface of said upper plate, and
wherein:
another side of at least one of said inner frame and said outer frame is connected on a diaphragm-mounting surface, which supports a circumferential edge of said diaphragm, and said inner frame and said outer frame are connected to each other at respective another side.

2. The speaker, as claimed in claim 1, wherein:
an interior angle between said inner frame and said outer frame is an acute angle at a connection section at which said inner frame and said outer frame are connected to each other.

3. The speaker, as claimed in claim 1, wherein:
said inner frame and said outer frame are overlapped each other at a connection section at which said inner frame and said outer frame are connected to each other.

4. The speaker, as claimed in claim 1, further comprising:
an abutment section, which is provided on one of said inner frame and said outer frame, said abutment section coming into contact with another thereof to connect said inner frame and said outer frame to each other, and providing a truss structure at a connection section at which said inner frame and said outer frame are connected to each other.

5. The speaker, as claimed in claim 1, wherein:
said inner frame and said outer frame are made of materials having different physical properties from each other.

6. The speaker, as claimed in claim 2, wherein:
said inner frame and said outer frame are made of materials having different physical properties from each other.

7. The speaker, as claimed in claim 3, wherein:
said inner frame and said outer frame are made of materials having different physical properties from each other.

8. The speaker, as claimed in claim 4, wherein:
said inner frame and said outer frame are made of materials having different physical properties from each other.
